(19) United States
(12) Patent Application Publication
(10) Pub. No.: US 2024/0320523 A1
(43) Pub. Date: Sep. 26, 2024

(54) Replacing Online Conversations Using Large Language Machine-Learned Models

(71) Applicant: Maplebear Inc., San Francisco, CA (US)

(72) Inventors: Ryan McColeman, Toronto (CA); Ryan Martin, Toronto (CA); Brent Scheibelhut, Toronto (CA); Shaun Navin Maharaj, Vaughan (CA); Mark Oberemk, Toronto (CA)

(21) Appl. No.: 18/605,580

(22) Filed: Mar. 14, 2024

Related U.S. Application Data
(60) Provisional application No. 63/453,424, filed on Mar. 20, 2023.

(51) Int. Cl. G06N 5/022; G06N 5/04

(52) U.S. Cl. CPC G06N 5/022; G06N 5/04

(57) ABSTRACT

An online system performs an inference task in conjunction with the model serving system or the interface system to continuously monitor conversations between requesting users and fulfillment users to determine whether the online system can intervene to automatically respond to a message sent by a sending party, rather than prompting the receiving party for a manual reply. Upon inferring that a message can be automatically responded to, the online system automatically provides a response to the message without the receiving party's manual involvement. The online system can further be augmented to classify and reroute certain requesting user or fulfillment user queries that impact an order's end state by intercepting the conversation on behalf of either party and performing one or more automated actions. If the message is action-oriented, the online system may perform one or more automated actions in response to the message.

### CROSS-REFERENCE TO RELATED APPLICATIONS

The present application claims the benefit of and priority to U.S. Provisional Application No. 63/453,424 filed on Mar. 20, 2023, which is incorporated by reference in its entirety.

### BACKGROUND

An online system provides a platform for connecting requesting users and fulfillment locations. In some instances, the online system generates a communication interface that allows a requesting user to communicate with a fulfillment user that is servicing the requesting user's order. Oftentimes, the requesting user or the fulfillment user may make an inquiry or request about the order to the other party that the other party would ordinarily have to manually reply, e.g., to aid in completion of the order. The need to await manual replies (from either party) can create undesired delays in fulfilling the requesting user's order.

### SUMMARY

In accordance with one or more aspects of the disclosure, an online system performs an inference task in conjunction with the model serving system or the interface system to continuously monitor conversations between requesting users and fulfillment users to determine whether the online system can intervene in the communications with an automated reply and/or an automated action. The online system may leverage a machine-learned language model to perform the inference. Based on the model's response to a crafted prompt based on the users' communications, the online system can determine when to intervene with an automated reply to a message sent by a sending party, i.e., without the receiving party's manual involvement. In one or more embodiments, the online system can further be augmented to classify and reroute certain requests that impact an order's end state by performing one or more automated actions. The online system continuously provides one or more messages from a conversation to the model serving system and/or the interface system and receives a response for each message that indicates whether the message is an inquiry, action-oriented, or under a time constraint. If the message is action-oriented, the online system may perform one or more automated actions.

### BRIEF DESCRIPTION OF THE DRAWINGS

FIG. 1A illustrates an example system environment for an online system, in accordance with one or more embodiments.

FIG. 1B illustrates an example system environment for an online system, in accordance with one or more embodiments.

FIG. 2 illustrates an example system architecture for an online system, in accordance with one or more embodiments.

FIG. 3 is an example messaging user interface, in accordance with one or more embodiments.

FIG. 4 is a flowchart for a method of inferring whether an automated reply or action can be generated for a message, in accordance with one or more embodiments.

### DETAILED DESCRIPTION

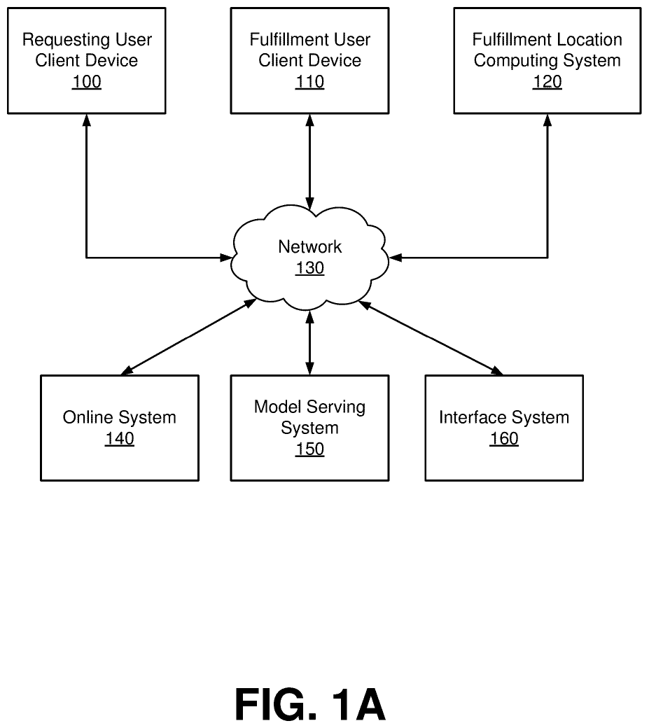

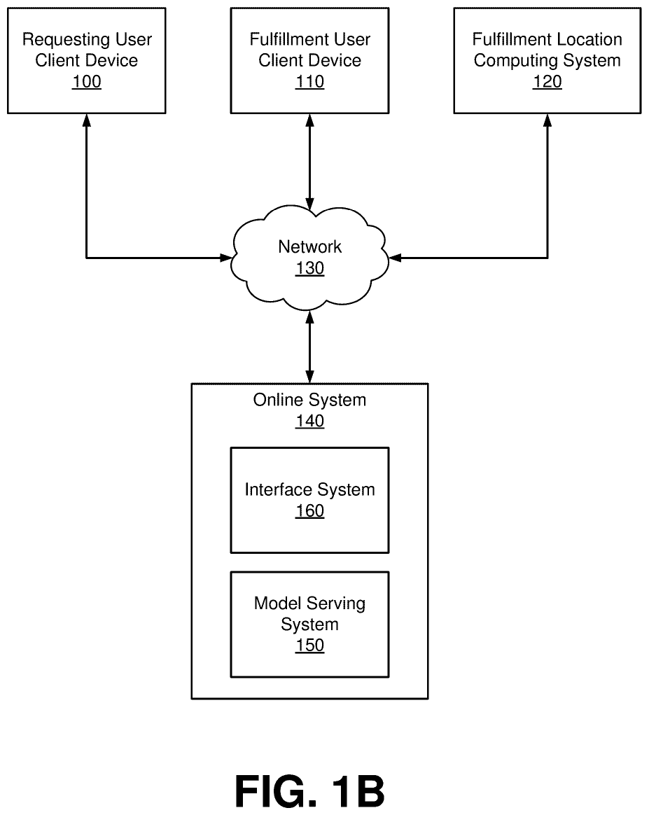

FIG. 1A illustrates an example system environment for an online system 140, in accordance with one or more embodiments. The system environment illustrated in FIG. 1A includes a requesting user client device 100, a fulfillment user client device 110, a fulfillment location computing system 120, a network 130, and an online system 140. Alternative embodiments may include more, fewer, or different components from those illustrated in FIG. 1A, and the functionality of each component may be divided between the components differently from the description below. Additionally, each component may perform their respective functionalities in response to a request from a human, or automatically without human intervention.

As used herein, requesting users, fulfillment users, and fulfillment locations may be generically referred to as “requesting users” of the online system 140. Additionally, while one requesting user client device 100, fulfillment user client device 110, and fulfillment location computing system 120 are illustrated in FIG. 1, any number of requesting users, fulfillment users, and fulfillment locations may interact with the online system 140. As such, there may be more than one requesting user client device 100, fulfillment user client device 110, or fulfillment location computing system 120.

The requesting user client device 100 is a client device through which a requesting user may interact with the fulfillment user client device 110, the fulfillment location computing system 120, or the online system 140. The requesting user client device 100 can be a personal or mobile computing device, such as a smartphone, a tablet, a laptop computer, or desktop computer. In some embodiments, the requesting user client device 100 executes a client application that uses an application programming interface (API) to communicate with the online system 140.

A requesting user uses the requesting user client device 100 to place an order with the online system 140. An order specifies a set of items to be delivered to the requesting user. An “item”, as used herein, means a good or product that can be provided to the requesting user through the online system 140. The order may include item identifiers (e.g., a stock keeping unit or a price look-up code) for items to be delivered to the requesting user and may include quantities of the items to be delivered. Additionally, an order may further include a delivery location to which the ordered items are to be delivered and a timeframe during which the items should be delivered. In some embodiments, the order also specifies one or more fulfillment locations from which the ordered items should be collected.

The requesting user client device 100 presents an ordering interface to the requesting user. The ordering interface is a requesting user interface that the requesting user can use to place an order with the online system 140. The ordering interface may be part of a client application operating on the requesting user client device 100. The ordering interface allows the requesting user to search for items that are available through the online system 140 and the requesting user can select which items to add to a “shopping list.” A “shopping list,” as used herein, is a tentative set of items that the requesting user has selected for an order but that has not yet been finalized for an order. The ordering interface allows a requesting user to update the shopping list, e.g., by changing the quantity of items, adding or removing items, or adding instructions for items that specify how the item should be collected.

The requesting user client device 100 may receive additional content from the online system 140 to present to a requesting user. For example, the requesting user client device 100 may receive coupons, recipes, or item suggestions. The requesting user client device 100 may present the received additional content to the requesting user as the requesting user uses the requesting user client device 100 to place an order (e.g., as part of the ordering interface).

Additionally, the requesting user client device 100 includes a communication interface that allows the requesting user to communicate with a fulfillment user that is servicing the requesting user's order. This communication interface allows the requesting user to input a text-based message to transmit to the fulfillment user client device 110 via the network 130. The fulfillment user client device 110 receives the message from the requesting user client device 100 and presents the message to the fulfillment user. The fulfillment user client device 110 also includes a communication interface that allows the fulfillment user to communicate with the requesting user. The fulfillment user client device 110 transmits a message provided by the fulfillment user to the requesting user client device 100 via the network 130. In some embodiments, messages sent between the requesting user client device 100 and the fulfillment user client device 110 are transmitted through the online system 140. In addition to text messages, the communication interfaces of the requesting user client device 100 and the fulfillment user client device 110 may allow the requesting user and the fulfillment user to communicate through audio or video communications, such as a phone call, a voice-over-IP call, or a video call.

The fulfillment user client device 110 is a client device through which a fulfillment user may interact with the requesting user client device 100, the fulfillment location computing system 120, or the online system 140. The fulfillment user client device 110 can be a personal or mobile computing device, such as a smartphone, a tablet, a laptop computer, or desktop computer. In some embodiments, the fulfillment user client device 110 executes a client application that uses an application programming interface (API) to communicate with the online system 140.

The fulfillment user client device 110 receives orders from the online system 140 for the fulfillment user to service. A fulfillment user services an order by collecting the items listed in the order from a fulfillment location. The fulfillment user client device 110 presents the items that are included in the requesting user's order to the fulfillment user in a collection interface. The collection interface is a requesting user interface that provides information to the fulfillment user on which items to collect for a requesting user's order and the quantities of the items. In some embodiments, the collection interface provides multiple orders from multiple requesting users for the fulfillment user to service at the same time from the same fulfillment location. The collection interface further presents instructions that the requesting user may have included related to the collection of items in the order. Additionally, the collection interface may present a location of each item in the fulfillment location, and may even specify a sequence in which the fulfillment user should collect the items for improved efficiency in collecting items. In some embodiments, the fulfillment user client device 110 transmits to the online system 140 or the requesting user client device 100 which items the fulfillment user has collected in real time as the fulfillment user collects the items.

The fulfillment user can use the fulfillment user client device 110 to keep track of the items that the fulfillment user has collected to ensure that the fulfillment user collects all of the items for an order. The fulfillment user client device 110 may include a barcode scanner that can determine an item identifier encoded in a barcode coupled to an item. The fulfillment user client device 110 compares this item identifier to items in the order that the fulfillment user is servicing, and if the item identifier corresponds to an item in the order, the fulfillment user client device 110 identifies the item as collected. In some embodiments, rather than or in addition to using a barcode scanner, the fulfillment user client device 110 captures one or more images of the item and determines the item identifier for the item based on the images. The fulfillment user client device 110 may determine the item identifier directly or by transmitting the images to the online system 140. Furthermore, the fulfillment user client device 110 determines a weight for items that are priced by weight. The fulfillment user client device 110 may prompt the fulfillment user to manually input the weight of an item or may communicate with a weighing system in the fulfillment location to receive the weight of an item.

When the fulfillment user has collected all of the items for an order, the fulfillment user client device 110 instructs a fulfillment user on where to deliver the items for a requesting user's order. For example, the fulfillment user client device 110 displays a delivery location from the order to the fulfillment user. The fulfillment user client device 110 also provides navigation instructions for the fulfillment user to travel from the fulfillment location to the delivery location. Where a fulfillment user is servicing more than one order, the fulfillment user client device 110 identifies which items should be delivered to which delivery location. The fulfillment user client device 110 may provide navigation instructions from the fulfillment location to each of the delivery locations. The fulfillment user client device 110 may receive one or more delivery locations from the online system 140 and may provide the delivery locations to the fulfillment user so that the fulfillment user can deliver the corresponding one or more orders to those locations. The fulfillment user client device 110 may also provide navigation instructions for the fulfillment user from the fulfillment location from which the fulfillment user collected the items to the one or more delivery locations.

In some embodiments, the fulfillment user client device 110 tracks the location of the fulfillment user as the fulfillment user delivers orders to delivery locations. The fulfillment user client device 110 collects location data and transmits the location data to the online system 140. The online system 140 may transmit the location data to the requesting user client device 100 for display to the requesting user such that the requesting user can keep track of when their order will be delivered. Additionally, the online system 140 may generate updated navigation instructions for the fulfillment user based on the fulfillment user's location. For example, if the fulfillment user takes a wrong turn while traveling to a delivery location, the online system 140 determines the fulfillment user's updated location based on location data from the fulfillment user client device 110 and generates updated navigation instructions for the fulfillment user based on the updated location.

In one or more embodiments, the fulfillment user is a single person who collects items for an order from a fulfillment location and delivers the order to the delivery location for the order. Alternatively, more than one person may serve the role as a fulfillment user for an order. For example, multiple people may collect the items at the fulfillment location for a single order. Similarly, the person who delivers an order to its delivery location may be different from the person or people who collected the items from the fulfillment location. In these embodiments, each person may have a fulfillment user client device 110 that they can use to interact with the online system 140.

Additionally, while the description herein may primarily refer to fulfillment users as humans, in some embodiments, some or all of the steps taken by the fulfillment user may be automated. For example, a semi- or fully-autonomous robot may collect items in a fulfillment location for an order and an autonomous vehicle may deliver an order to a requesting user from a fulfillment location.

The fulfillment location computing system 120 is a computing system operated by a fulfillment location that interacts with the online system 140. As used herein, a “fulfillment location” is an entity that operates a “fulfillment location,” which is a store, warehouse, or other building from which a fulfillment user can collect items. The fulfillment location computing system 120 stores and provides item data to the online system 140 and may regularly update the online system 140 with updated item data. For example, the fulfillment location computing system 120 provides item data indicating which items are available at a fulfillment location and the quantities of those items. Additionally, the fulfillment location computing system 120 may transmit updated item data to the online system 140 when an item is no longer available at the fulfillment location. Additionally, the fulfillment location computing system 120 may provide the online system 140 with updated item prices, sales, or availabilities. Additionally, the fulfillment location computing system 120 may receive payment information from the online system 140 for orders serviced by the online system 140.

The requesting user client device 100, the fulfillment user client device 110, the fulfillment location computing system 120, and the online system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of standard layers used to describe a physical or virtual network, such as the physical layer, the data link layer, the network layer, the transport layer, the session layer, the presentation layer, and the application layer. The network 130 may include physical media for communicating data from one computing device to another computing device, such as MPLS lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online system 140 is an online system by which requesting users can order items to be provided to them by a fulfillment user from a fulfillment location. The online system 140 receives orders from a requesting user client device 100 through the network 130. The online system 140 selects a fulfillment user to service the requesting user's order and transmits the order to a fulfillment user client device 110 associated with the fulfillment user. The fulfillment user collects the ordered items from a fulfillment location and delivers the ordered items to the requesting user. The online system 140 may charge a requesting user for the order and may forward a portion to the fulfillment user and the fulfillment location.

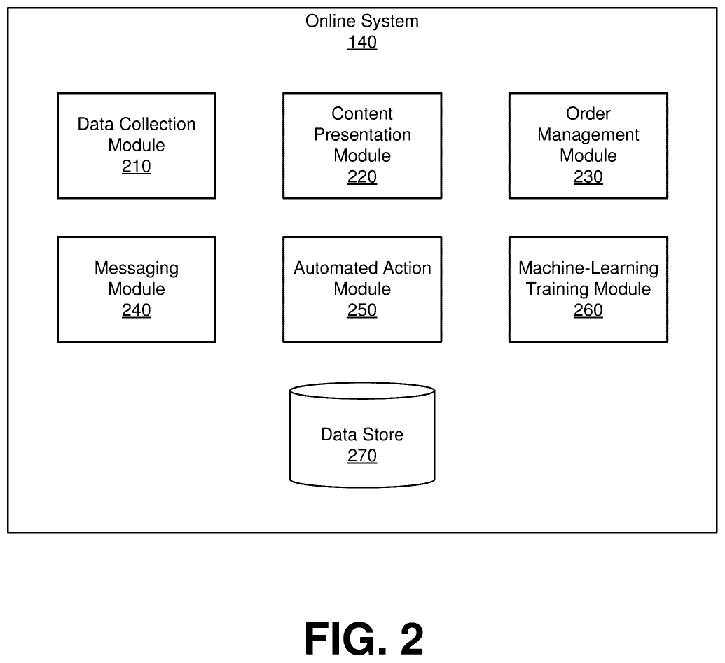

As an example, the online system 140 may allow a requesting user to order groceries from a grocery store fulfillment location. The requesting user's order may specify which groceries they want delivered from the grocery store and the quantities of each of the groceries. The requesting user's client device 100 transmits the requesting user's order to the online system 140 and the online system 140 selects a fulfillment user to travel to the grocery store fulfillment location to collect the groceries ordered by the requesting user. Once the fulfillment user has collected the groceries ordered by the requesting user, the fulfillment user delivers the groceries to a location transmitted to the fulfillment user client device 110 by the online system 140. The online system 140 is described in further detail below with regards to FIG. 2.

The model serving system 150 receives requests from the online system 140 to perform inference tasks using machine-learned models. The inference tasks include, but are not limited to, natural language processing (NLP) tasks, audio processing tasks, image processing tasks, video processing tasks, and the like. In one or more embodiments, the machine-learned models deployed by the model serving system 150 are models configured to perform one or more NLP tasks. The NLP tasks include, but are not limited to, text generation, query processing, machine translation, chatbot applications, and the like. In one or more embodiments, the language model is configured as a transformer neural network architecture. Specifically, the transformer model is coupled to receive sequential data tokenized into a sequence of input tokens and generates a sequence of output tokens depending on the inference task to be performed.

The model serving system 150 receives a request including input data (e.g., text data, audio data, image data, or video data) and encodes the input data into a set of input tokens. The model serving system 150 applies the machine-learned model to generate a set of output tokens. Each token in the set of input tokens or the set of output tokens may correspond to a text unit. For example, a token may correspond to a word, a punctuation symbol, a space, a phrase, a paragraph, and the like. For an example query processing task, the language model may receive a sequence of input tokens that represent a query and generate a sequence of output tokens that represent a response to the query. For a translation task, the transformer model may receive a sequence of input tokens that represent a paragraph in German and generate a sequence of output tokens that represents a translation of the paragraph or sentence in English. For a text generation task, the transformer model may receive a prompt and continue the conversation or expand on the given prompt in human-like text.

When the machine-learned model is a language model, the sequence of input tokens or output tokens are arranged as a tensor with one or more dimensions, for example, one dimension, two dimensions, or three dimensions. For example, one dimension of the tensor may represent the number of tokens (e.g., length of a sentence), one dimension of the tensor may represent a sample number in a batch of input data that is processed together, and one dimension of the tensor may represent a space in an embedding space. However, it is appreciated that in other embodiments, the input data or the output data may be configured as any number of appropriate dimensions depending on whether the data is in the form of image data, video data, audio data, and the like. For example, for three-dimensional image data, the input data may be a series of pixel values arranged along a first dimension and a second dimension, and further arranged along a third dimension corresponding to RGB channels of the pixels.

In one or more embodiments, the language models are large language models (LLMs) that are trained on a large corpus of training data to generate outputs for the NLP tasks. An LLM may be trained on massive amounts of text data, often involving billions of words or text units. The large amount of training data from various data sources allows the LLM to generate outputs for many inference tasks. An LLM may have a significant number of parameters in a deep neural network (e.g., transformer architecture), for example, at least 1 billion, at least 15 billion, at least 135 billion, at least 175 billion, at least 500 billion, at least 1 trillion, at least 1.5 trillion parameters.

Since an LLM has significant parameter size and the amount of computational power for inference or training the LLM is high, the LLM may be deployed on an infrastructure configured with, for example, supercomputers that provide enhanced computing capability (e.g., graphic processor units (GPUs) for training or deploying deep neural network models. In one instance, the LLM may be trained and hosted on a cloud infrastructure service. The LLM may be trained by the online system 140 or entities/systems different from the online system 140. An LLM may be trained on a large amount of data from various data sources. For example, the data sources include websites, articles, posts on the web, and the like. From this massive amount of data coupled with the computing power of LLMs, the LLM is able to perform various inference tasks and synthesize and formulate output responses based on information extracted from the training data.

In one or more embodiments, when the machine-learned model including the LLM is a transformer-based architecture, the transformer has a generative pre-training (GPT) architecture including a set of decoders that each perform one or more operations to input data to the respective decoder. A decoder may include an attention operation that generates keys, queries, and values from the input data to the decoder to generate an attention output. In another embodiment, the transformer architecture may have an encoder-decoder architecture and includes a set of encoders coupled to a set of decoders. An encoder or decoder may include one or more attention operations.

While a LLM with a transformer-based architecture is described as a primary embodiment, it is appreciated that in other embodiments, the language model can be configured as any other appropriate architecture including, but not limited to, long short-term memory (LSTM) networks, Markov networks, BART, generative-adversarial networks (GAN), diffusion models (e.g., Diffusion-LM), and the like. The LLM is configured to receive a prompt and generate a response to the prompt. The prompt may include a task request and additional contextual information that is useful for responding to the query. The LLM infers the response to the query from the knowledge that the LLM was trained on and/or from the contextual information included in the prompt.

In one or more embodiments, the inference task for the model serving system 150 can primarily be based on reasoning and summarization of knowledge specific to the online system 140, rather than relying on general knowledge encoded in the weights of the machine-learned model of the model serving system 150. Thus, one type of inference task may be to perform various types of queries on large amounts of data in an external corpus in conjunction with the machine-learned model of the model serving system 150. For example, the inference task may be to perform question-answering, text summarization, text generation, and the like based on information contained in the external corpus.

Thus, in one or more embodiments, the online system 140 is connected to an interface system 160. The interface system 160 receives an external corpus of data from the online system 140 and builds a structured index over the data using another machine-learned language model or heuristics. The interface system 160 receives one or more task requests from the online system 140 based on the external data. The interface system 160 constructs one or more prompts for input to the model serving system 150. A prompt may include the task request of the requesting user and context obtained from the structured index of the external data. In one instance, the context in the prompt includes portions of the structured indices as contextual information for the query. The interface system 160 obtains one or more responses to the query from the model serving system 150 and synthesizes a response. While the online system 140 can generate a prompt using the external data as context, oftentimes, the amount of information in the external data exceeds prompt size limitations configured by the machine-learned language model. The interface system 160 can resolve prompt size limitations by generating a structured index of the data and offers data connectors to external data and provides a flexible connector to the external corpus.

In one or more embodiments, the online system 140 performs an inference task in conjunction with the model serving system 150 and/or the interface system 160 to continuously monitor conversations between requesting users and fulfillment users to determine whether the online system 140 can intervene in responding to a message sent by a sending party, e.g., rather than prompting the receiving party for a manual reply, or performing one or more automated actions in response to the message. For example, an example message from a fulfillment user may be “What is your door code to your complex?” The online system 140 constructs a prompt including the message, a task request to the LLM on whether an automated reply can be generated for the message, and other contextual information including the current chat history or previous interactions between requesting users and fulfillment users. As an example, the online system 140 receives a response from the LLM that recites “The door code is 1234.” The online system 140 provides an automated reply to the message without the receiving party's (e.g., requesting user's) manual involvement. Thus, the online system 140 performs an action of adding buzzer instructions to the user's order for a later state when the fulfillment user delivers the order.

In one or more embodiments, the online system 140 can further be augmented to classify and reroute certain requesting user or fulfillment user requests that impact an order's end state by intervening on behalf of either party and performing one or more automated actions based on the content of the message. The online system 140 continuously provides one or more messages from a conversation to the model serving system 150 and/or the interface system 160 and receives a response for each message that indicates whether the message is an inquiry, action-oriented, or under a time constraint.

If the message is determined to be an inquiry, the online system 140 may determine whether the online system 140 can intervene with an automated reply. For example, if a user is inquiring about information known by the online system 140, e.g., information relating to one or more users, information relating to items, or information relating to fulfillment locations, the online system 140 may intervene with automated replies. On the other hand, if the user is inquiring about information outside the knowledge scope of the online system 140, the online system 140 may prompt the receiving party to provide a manual reply to the inquiry. If a message (e.g., a message from a requesting user requesting that bananas be added in an order) is determined to be action-oriented, the message is one that can be automatically replied to by the online system 140 by performing an automated action based on various types of contextual information, including previous interactions between fulfillment users and requesting users, the history of the current conversation, and the like. From the LLM's response, the online system 140 extracts a desired action to be performed for the message (e.g., add bananas to order).

In one or more embodiments, the responses from the LLM on whether a message is action-oriented and can be automatically replied to in a manner determined based on previous chat history across different fulfillment users and requesting users of the online system 140 to infer common interactions that previously resulted in certain actions being performed in response to the messages. Specifically, in one or more embodiments, the online system 140 provides the interface system 160 with a collected history of previous chats between fulfillment users and requesting users that provide insight into which messages are action-oriented and what types of desired actions can be performed to respond to a message. The online system 140 provides the messages of a conversation to the interface system 160 such that the interface system 160 constructs the appropriate prompts to the model serving system 150 based on the database of previous chat histories. In other instances, the online system 140 provides the messages of a conversation directly to the model serving system 150 with a generated prompt that includes the message and contextual information about previous chat histories between requesting users and fulfillment users.

In one or more embodiments, the online system 140 maintains a set of rule actions which are categories of actions that can automatically be invoked in response to a message. For example, the rule actions may include automatically adding requesting user item requests to an order, summarizing delivery instructions from a requesting user, responding to the message in the conversation, and the like. Responsive to determining a desired action from the response of the LLM, the online system 140 determines whether an appropriate rule action (e.g., add items to an existing order) that corresponds to the desired action exists. If the rule action exists, the online system 140 invokes the desired action for the order (e.g., update requesting user's order to add bananas) and automatically sends a notification message (e.g., “I have added bananas to your order”) to the sending party from the receiving party.

In this manner, the online system 140 identifies messages for which automated actions or replies can be sent, i.e., by automatically intervening in conversations on behalf of the receiving party. This allows the online system 140 to eliminate human interaction when responding to action-oriented messages, allowing for automated and efficient processing of requesting user orders.

FIG. 1B illustrates an example system environment for an online system 140, in accordance with one or more embodiments. The system environment illustrated in FIG. 1B includes a requesting user client device 100, a fulfillment user client device 110, a fulfillment location computing system 120, a network 130, and an online system 140. Alternative embodiments may include more, fewer, or different components from those illustrated in FIG. 1B, and the functionality of each component may be divided between the components differently from the description below. Additionally, each component may perform their respective functionalities in response to a request from a human, or automatically without human intervention.

The example system environment in FIG. 1A illustrates an environment where the model serving system 150 and/or the interface system 160 are each managed by an entity separate from the entity managing the online system 140. In one or more embodiments, as illustrated in the example system environment in FIG. 1B, the model serving system 150 or the interface system 160 is managed and deployed by the entity managing the online system 140.

FIG. 2 illustrates an example system architecture for an online system 140, in accordance with some embodiments. The system architecture illustrated in FIG. 2 includes a data collection module 210, a content presentation module 220, an order management module 230, a messaging module 240, an automated action module 250, a machine learning training module 260, and a data store 270. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 210 collects data used by the online system 140 and stores the data in the data store 270. The data collection module 210 may only collect data describing a requesting user if the requesting user has previously explicitly consented to the online system 140 collecting data describing the requesting user. Additionally, the data collection module 210 may encrypt all data, including sensitive or personal data, describing requesting users.

For example, the data collection module 210 collects requesting user data, which is information or data that describe characteristics of a requesting user. Requesting user data may include a requesting user's name, address, shopping preferences, favorite items, or stored payment instruments. The requesting user data also may include default settings established by the requesting user, such as a default fulfillment location, payment instrument, delivery location, or delivery timeframe. The data collection module 210 may collect the requesting user data from sensors on the requesting user client device 100 or based on the requesting user's interactions with the online system 140.

The data collection module 210 also collects item data, which is information or data that identifies and describes items that are available at a fulfillment location. The item data may include item identifiers for items that are available and may include quantities of items associated with each item identifier. Additionally, item data may also include attributes of items such as the size, color, weight, stock keeping unit (SKU), or serial number for the item. The item data may further include ordering rules associated with each item, if they exist. For example, age-restricted items such as alcohol and tobacco are flagged accordingly in the item data. Item data may also include information that is useful for predicting the availability of items in fulfillment locations. For example, for each item-fulfillment location combination (a particular item at a particular warehouse), the item data may include a time that the item was last found, a time that the item was last not found (a fulfillment user looked for the item but could not find it), the rate at which the item is found, or the popularity of the item. The data collection module 210 may collect item data from a fulfillment location computing system 120, a fulfillment user client device 110, or the requesting user client device 100.

An item category is a set of items that are a similar type of item. Items in an item category may be considered to be equivalent to each other or that may be replacements for each other in an order. For example, different brands of sourdough bread may be different items, but these items may be in a “sourdough bread” item category. The item categories may be human-generated and human-populated with items. The item categories also may be generated automatically by the online system 140 (e.g., using a clustering algorithm).

The data collection module 210 also collects fulfillment user data, which is information or data that describes characteristics of fulfillment users. For example, the fulfillment user data for a fulfillment user may include the fulfillment user's name, the fulfillment user's location, how often the fulfillment user has services orders for the online system 140, a requesting user rating for the fulfillment user, which fulfillment locations the fulfillment user has collected items at, or the fulfillment user's previous shopping history. Additionally, the fulfillment user data may include preferences expressed by the fulfillment user, such as their preferred fulfillment locations to collect items at, how far they are willing to travel to deliver items to a requesting user, how many items they are willing to collect at a time, timeframes within which the fulfillment user is willing to service orders, or payment information by which the fulfillment user is to be paid for servicing orders (e.g., a bank account). The data collection module 210 collects fulfillment user data from sensors of the fulfillment user client device 110 or from the fulfillment user's interactions with the online system 140.

Additionally, the data collection module 210 collects order data, which is information or data that describes characteristics of an order. For example, order data may include item data for items that are included in the order, a delivery location for the order, a requesting user associated with the order, a fulfillment location from which the requesting user wants the ordered items collected, or a timeframe within which the requesting user wants the order delivered. Order data may further include information describing how the order was serviced, such as which fulfillment user serviced the order, when the order was delivered, or a rating that the requesting user gave the delivery of the order. In some embodiments, the order data includes requesting user data for requesting users associated with the order, such as requesting user data for a requesting user who placed the order or fulfillment user data for a fulfillment user who serviced the order.

In one or more embodiments, the data collection module 210 also collects communication data, which is different types of communication between fulfillment users and requesting users of the online system 140. For example, the data collection module 210 may obtain text-based, audio-call, video-call based communications between different fulfillment users and requesting users of the online system 140 as orders are submitted and fulfilled. The data collection module 210 may store the communication information by individual requesting user, individual fulfillment user, per geographical region, per subset of requesting users having similar attributes, and the like.

The content presentation module 220 selects content for presentation to a requesting user. For example, the content presentation module 220 selects which items to present to a requesting user while the requesting user is placing an order. The content presentation module 220 generates and transmits the ordering interface for the requesting user to order items. The content presentation module 220 populates the ordering interface with items that the requesting user may select for adding to their order. In some embodiments, the content presentation module 220 presents a catalog of all items that are available to the requesting user, which the requesting user can browse to select items to order. The content presentation module 220 also may identify items that the requesting user is most likely to order and present those items to the requesting user. For example, the content presentation module 220 may score items and rank the items based on their scores. The content presentation module 220 displays the items with scores that exceed some threshold (e.g., the top n items or the p percentile of items).

The content presentation module 220 may use an item selection model to score items for presentation to a requesting user. An item selection model is a machine learning model that is trained to score items for a requesting user based on item data for the items and requesting user data for the requesting user. For example, the item selection model may be trained to determine a likelihood that the requesting user will order the item. In some embodiments, the item selection model uses item embeddings describing items and requesting user embeddings describing requesting users to score items. These item embeddings and requesting user embeddings may be generated by separate machine learning models and may be stored in the data store 270.

In some embodiments, the content presentation module 220 scores items based on a search query received from the requesting user client device 100. A search query is free text for a word or set of words that indicate items of interest to the requesting user. The content presentation module 220 scores items based on a relatedness of the items to the search query. For example, the content presentation module 220 may apply natural language processing (NLP) techniques to the text in the search query to generate a search query representation (e.g., an embedding) that represents characteristics of the search query. The content presentation module 220 may use the search query representation to score candidate items for presentation to a requesting user (e.g., by comparing a search query embedding to an item embedding).

In some embodiments, the content presentation module 220 scores items based on a predicted availability of an item. The content presentation module 220 may use an availability model to predict the availability of an item. An availability model is a machine learning model that is trained to predict the availability of an item at a fulfillment location. For example, the availability model may be trained to predict a likelihood that an item is available at a fulfillment location or may predict an estimated number of items that are available at a fulfillment location. The content presentation module 220 may weight the score for an item based on the predicted availability of the item. Alternatively, the content presentation module 220 may filter out items from presentation to a requesting user based on whether the predicted availability of the item exceeds a threshold.

In one or more embodiments, the content presentation module 220 receives one or more recommendations for presentation to the requesting user while the requesting user is engaged with the ordering interface. The list of ordered items of a requesting user may be referred to as a basket. As described in conjunction with FIGS. 1A and 1B, the recommendations are generated based on the inferred purpose of the basket of the requesting user and include one or more suggestions to the requesting user to better fulfill the purpose of the basket.

In one instance, the recommendations are in the form of one or more equivalent baskets that are modifications to an existing basket that serve the same or similar purpose as the original basket. The equivalent basket is adjusted with respect to metrics such as cost, healthiness, whether the basket is sponsored, and the like. For example, an equivalent basket may be a healthier option compared to the existing basket, a less expensive option compared to the existing basket, and the like. The content presentation module 220 may present the equivalent basket to the requesting user via the ordering interface with an indicator that states how an equivalent basket improves or is different from the existing basket (e.g., more cost-effective, healthier, sponsored by a certain organization). The content presentation module 220 may allow the requesting user to swap the existing basket with an equivalent basket.

In one instance, when the basket includes a list of edible ingredients, the recommendations are in the form of a list of potential recipes the ingredients can fulfill, and a list of additional ingredients to fulfill each recipe. The content presentation module 220 may present each suggested recipe and the list of additional ingredients for fulfilling the recipe to the requesting user. The content presentation module 220 may allow the requesting user to automatically place one or more additional ingredients in the basket of the requesting user.

The order management module 230 that manages orders for items from requesting users. The order management module 230 receives orders from a requesting user client device 100 and assigns the orders to fulfillment users for service based on fulfillment user data. For example, the order management module 230 assigns an order to a fulfillment user based on the fulfillment user's location and the location of the fulfillment location from which the ordered items are to be collected. The order management module 230 may also assign an order to a fulfillment user based on how many items are in the order, a vehicle operated by the fulfillment user, the delivery location, the fulfillment user's preferences on how far to travel to deliver an order, the fulfillment user's ratings by requesting users, or how often a fulfillment user agrees to service an order.

In some embodiments, the order management module 230 determines when to assign an order to a fulfillment user based on a delivery timeframe requested by the requesting user with the order. The order management module 230 computes an estimated amount of time that it would take for a fulfillment user to collect the items for an order and deliver the ordered item to the delivery location for the order. The order management module 230 assigns the order to a fulfillment user at a time such that, if the fulfillment user immediately services the order, the fulfillment user is likely to deliver the order at a time within the timeframe. Thus, when the order management module 230 receives an order, the order management module 230 may delay in assigning the order to a fulfillment user if the timeframe is far enough in the future.

When the order management module 230 assigns an order to a fulfillment user, the order management module 230 transmits the order to the fulfillment user client device 110 associated with the fulfillment user. The order management module 230 may also transmit navigation instructions from the fulfillment user's current location to the fulfillment location associated with the order. If the order includes items to collect from multiple fulfillment locations, the order management module 230 identifies the fulfillment locations to the fulfillment user and may also specify a sequence in which the fulfillment user should visit the fulfillment locations.

The order management module 230 may track the location of the fulfillment user through the fulfillment user client device 110 to determine when the fulfillment user arrives at the fulfillment location. When the fulfillment user arrives at the fulfillment location, the order management module 230 transmits the order to the fulfillment user client device 110 for display to the fulfillment user. As the fulfillment user uses the fulfillment user client device 110 to collect items at the fulfillment location, the order management module 230 receives item identifiers for items that the fulfillment user has collected for the order. In some embodiments, the order management module 230 receives images of items from the fulfillment user client device 110 and applies computer-vision techniques to the images to identify the items depicted by the images. The order management module 230 may track the progress of the fulfillment user as the fulfillment user collects items for an order and may transmit progress updates to the requesting user client device 100 that describe which items have been collected for the requesting user's order.

In some embodiments, the order management module 230 tracks the location of the fulfillment user within the fulfillment location. The order management module 230 uses sensor data from the fulfillment user client device 110 or from sensors in the fulfillment location to determine the location of the fulfillment user in the fulfillment location. The order management module 230 may transmit to the fulfillment user client device 110 instructions to display a map of the fulfillment location indicating where in the fulfillment location the fulfillment user is located. Additionally, the order management module 230 may instruct the fulfillment user client device 110 to display the locations of items for the fulfillment user to collect, and may further display navigation instructions for how the fulfillment user can travel from their current location to the location of a next item to collect for an order.

The order management module 230 determines when the fulfillment user has collected all of the items for an order. For example, the order management module 230 may receive a message from the fulfillment user client device 110 indicating that all of the items for an order have been collected. Alternatively, the order management module 230 may receive item identifiers for items collected by the fulfillment user and determine when all of the items in an order have been collected. When the order management module 230 determines that the fulfillment user has completed an order, the order management module 230 transmits the delivery location for the order to the fulfillment user client device 110. The order management module 230 may also transmit navigation instructions to the fulfillment user client device 110 that specify how to travel from the fulfillment location to the delivery location, or to a subsequent fulfillment location for further item collection. The order management module 230 tracks the location of the fulfillment user as the fulfillment user travels to the delivery location for an order, and updates the requesting user with the location of the fulfillment user so that the requesting user can track the progress of their order. In some embodiments, the order management module 230 computes an estimated time of arrival for the fulfillment user at the delivery location and provides the estimated time of arrival to the requesting user.

In some embodiments, the order management module 230 facilitates communication between the requesting user client device 100 and the fulfillment user client device 110. As noted above, a requesting user may use a requesting user client device 100 to send a message to the fulfillment user client device 110. The order management module 230 receives the message from the requesting user client device 100 and transmits the message to the fulfillment user client device 110 for presentation to the fulfillment user. The fulfillment user may use the fulfillment user client device 110 to send a message to the requesting user client device 100 in a similar manner.

The order management module 230 coordinates payment by the requesting user for the order. The order management module 230 uses payment information provided by the requesting user (e.g., a credit card number or a bank account) to receive payment for the order. In some embodiments, the order management module 230 stores the payment information for use in subsequent orders by the requesting user. The order management module 230 computes a total cost for the order and charges the requesting user that cost. The order management module 230 may provide a portion of the total cost to the fulfillment user for servicing the order, and another portion of the total cost to the fulfillment location.

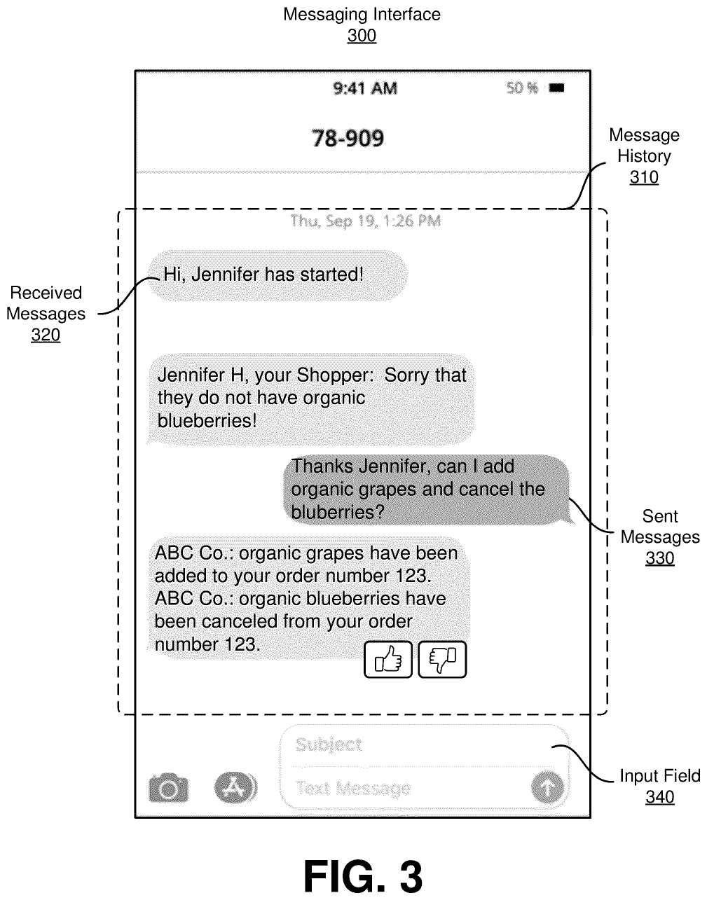

The messaging module 240 facilitates communication between the requesting user client device 100 and the fulfillment user client device 110. As noted above, a requesting user may use a requesting user client device 100 to communicate with a fulfillment user via the fulfillment user client device 110. The messaging module 240 receives the message from the requesting user client device 100 and transmits the message to the fulfillment user client device 110 for presentation to the fulfillment user. The fulfillment user may use the fulfillment user client device 110 to send a message to the requesting user client device 100 in a similar manner. In one or more embodiments, the messaging module 240 may generate a messaging user interface for each client device that includes messages passed between two or more devices. A messaging user interface is an embodiment of a communication interface. An example messaging user interface is provided in FIG. 3. Communications between the requesting user and the fulfillment user may be provided to the automated action module 250.

The automated action module 250 retrieves messages occurring between a requesting user client device 100 and a fulfillment user client device 110 (e.g., from the messaging module 240), and determines whether a message sent by a sending party can be automatically processed rather than prompting the receiving party for a manual reply. Specifically, the automated action module 250 continuously monitors and retrieves messages between a requesting user and a fulfillment user from the order management module 230. In one or more embodiments, the automated action module 250 determines whether a message sent by a sending party can be automatically responded to rather than prompting the receiving party for a manual reply.

The automated action module 250 constructs a prompt and a task request to the LLM on whether an automated reply can be generated for the message. An example prompt to the LLM of the model serving system 150 may be:
“Given [current chat history], what is a response to the message ‘what is the code to your complex?’ if any?”
   The automated action module 250 may receive a response from the LLM that may be:
“The code is 1234.”
   The automated action module 250 may provide the response back to the messaging module 240 such that an automated message can be sent to the sending party without manual involvement by the receiving party. The content associated with the response (e.g., “the code is 1234”) may be obtained from prior chat history where the content was previously mentioned (e.g., in a prior chat message where the requesting user's code was previously provided). The content may also be related to other stored data relevant to the parties, e.g., a fulfillment user may be requesting a delivery address of the requesting user, which may be stored in the requesting user's data.

In one or more embodiments, given a response from the LLM, the automated action module 250 obtains a confidence level of the response from the LLM. If the confidence level of the response is above a threshold value, then the automated action module 250 sends an automated message (i.e., an automated reply) to the sending party. In one instance, the confidence level is determined by comparing the reply to previous replies of similar messages or requests, comparing for synonymous text, tone, context, and the like. In one instance, the confidence level can be determined by applying a machine-learned model to the response, where parameters of the machine-learned model can be trained based on training data including the previous replies.

In one or more embodiments, the automated action module 250 is augmented to classify and reroute certain requesting user or fulfillment user queries that impact an order's end state by intercepting the conversation on behalf of either party and performing one or more automated actions based on the message. The automated action module 250 generates a prompt for the model serving system 150 that includes a request to infer whether the message is action-oriented or an inquiry and what types of desired actions can be inferred from the message.

For example, a requesting user may communicate to a fulfillment user to “please do not ring the doorbell of my house when dropping off my order.” An example prompt to the LLM of the model serving system 150 may be:
“What is a desired action in the message ‘please do not ring the doorbell of my house when dropping off my order’ if any?”
   The response from the LLM may be:
“This is an action-oriented message and an example response to this message is “Okay I will not ring the doorbell.” and an action to perform is to add “do not ring doorbell” to the delivery instructions.”
   The automated action module 250 may receive the LLM's response and extract (1) an example reply to the sending party, (2) a desired action to be performed for the message, which is to add “do not ring doorbell” to the delivery instructions for the order, or some combination thereof.

As described in conjunction with FIG. 1, in one or more embodiments, the responses from the LLM on whether a message is action-oriented and can be automatically responded to is determined based on previous chat history across different fulfillment users and requesting users of the online system 140 to infer common types of interactions. Specifically, in one or more embodiments, the automated action module 250 may provide the interface system 160 with a collected history of previous communications (e.g., text messages, audio and video calls) between fulfillment users and requesting users obtained from the data collection module 210. The communication information can be used to provide external data or context to the LLM that provides insight into which messages are action-oriented and what types of desired actions can be performed to respond to a message. The automated action module 250 may also provide actions that were undertaken in response to the previous communications. The LLM can learn relations between the messages in the previous communications and the actions undertaken to better classify action-oriented messages and to better predict example replies and/or desired actions from messages.

In one or more embodiments, for a given conversation between a requesting user and a fulfillment user, the automated action module 250 may also provide the model serving system 150 and/or the interface system 160 with a collected history of previous communications of that fulfillment user or that requesting user. In this manner, the LLM can generate automated replies to messages that mimic the individual fulfillment user's or individual requesting user's prior and future interactions in the interest of making the automated interactions more seamless.

In one instance, the automated action module 250 maintains a set of rule actions which can be invoked in the case that an action is to be performed for a message. Thus, the set of rule actions represents a set of categories of actions that are approved or allowed by administrators of the online system 140 for automatic invocation as a response to an action-oriented message. In one instance, the set of rule actions may include, but are not limited to, automatically adding requested items to an order, adding a note from a requesting user to delivery instructions for the order when the order is about to be delivered, simply responding to the sending party with known information (e.g., door code for residence), otherwise modifying items in an order (e.g., items to be obtained, quantity of an item, substitution item), otherwise modifying delivery instructions (e.g., changing delivery address, changing delivery time or date, changing special instructions), and the like.

In one instance, the set of rule actions maintained by the automated action module 250 may also be obtained or identified from the previous communications between requesting users and fulfillment users or other appropriate data sources. In one or more embodiments, a rule action may be associated with one or more API calls (e.g., REST API, RPC call or gRPC call). For example, the action of automatically adding requested items to an order may be associated with an API call to an add order API with schema (specifying input and expected output types), the action of adding or modifying delivery instructions may be associated with an API call to an update delivery instructions API with schema, and the like. Therefore, once the automated action module 250 identifies actions to take in response to a message, the API calls associated with the action may be invoked and executed to perform the desired response.

Responsive to identifying a desired action from the response of the LLM, the automated action module 250 determines whether a rule action for the request exists, and invokes the identified action if a corresponding rule action is present for the identified action. The automated action module 250 also generates a message notifying the sending party of an automated reply and/or that an action has been performed. The automated message may be sent to the messaging module 240 such that the message is sent as an automated reply to the sending party via the messaging user interface (e.g., chat window, audio or video call).

In one or more embodiments, responsive to an automated message sent by the automated action module 250, the messaging module 240 may generate one or more UI elements on the messaging user interface that allows the receiving party to provide positive, neutral, or negative feedback upon reviewing the automated action. For example, responsive to a user requesting addition of organic grapes to the user's order, the automated action module 250 may identify the action of adding an item to an existing order, trigger the relevant API calls to update the user's order. The automated action module 250 may also push a message “organic grapes have been added to your order” without the fulfillment user responding to the message. Responsive to review on the UI, the fulfillment user may press a positive indication element (e.g., thumbs up) button generated on the UI to indicate that the automated action is a correct one and acknowledgement of the automated action.

In one or more embodiments, the automated action module 250 tracks whether the response from the LLM for one or more messages are missing a desired action and/or have identified a desired action but that desired action is missing from the set of rule actions maintained by the automated action module 250. In response, the automated action module 250 may forgo intervention of the messages and progress to letting the receiving party respond to the sending party's messages. In such embodiments, the LLM or the automated action module 250 may further collect messages or requests with similar actions and may update scores for each group of missing actions based on their frequency of invocation. If the score of the missing action is above a threshold value, the administrators of the automated action module 250 may determine whether to add such an action to the list of rule actions, such that the action can be also automated in the future.

The machine learning training module 260 trains machine learning models used by the online system 140. For example, the machine learning module 230 may train the item selection model, the availability model, or any of the machine-learned models deployed by the model serving system 150. The online system 140 may use machine learning models to perform functionalities described herein. Example machine learning models include regression models, support vector machines, naïve bayes, decision trees, k nearest neighbors, random forest, boosting algorithms, k-means, and hierarchical clustering. The machine learning models may also include neural networks, such as perceptrons, multilayer perceptrons, convolutional neural networks, recurrent neural networks, sequence-to-sequence models, generative adversarial networks, or transformers.

Each machine learning model includes a set of parameters. A set of parameters for a machine learning model are parameters that the machine learning model uses to process an input. For example, a set of parameters for a linear regression model may include weights that are applied to each input variable in the linear combination that comprises the linear regression model. Similarly, the set of parameters for a neural network may include weights and biases that are applied at each neuron in the neural network. The machine learning training module 260 generates the set of parameters for a machine learning model by “training” the machine learning model. Once trained, the machine learning model uses the set of parameters to transform inputs into outputs.

The machine learning training module 260 trains a machine learning model based on a set of training examples. Each training example includes input data to which the machine learning model is applied to generate an output. For example, each training example may include requesting user data, fulfillment user data, item data, or order data. In some cases, the training examples also include a label which represents an expected output of the machine learning model. In these cases, the machine learning model is trained by comparing its output from input data of a training example to the label for the training example.

The machine learning training module 260 may apply an iterative process to train a machine learning model whereby the machine learning training module 260 trains the machine learning model on each of the set of training examples. To train a machine learning model based on a training example, the machine learning training module 260 applies the machine learning model to the input data in the training example to generate an output. The machine learning training module 260 scores the output from the machine learning model using a loss function. A loss function is a function that generates a score for the output of the machine learning model such that the score is higher when the machine learning model performs poorly and lower when the machine learning model performs well. In cases where the training example includes a label, the loss function is also based on the label for the training example. Some example loss functions include the mean square error function, the mean absolute error, hinge loss function, and the cross entropy loss function. The machine learning training module 260 updates the set of parameters for the machine learning model based on the score generated by the loss function. For example, the machine learning training module 260 may apply gradient descent to update the set of parameters.

The machine learning training module 260 may perform fine-tuning of the one or more machine learning models. To perform fine-tuning, the machine learning training module 260 obtains training data derived from feedback data. In one or more embodiments, the machine learning training module 260 identifies positive instances of feedback where users provided positive feedback on message intervention. In another embodiment, the online system 140 identifies the positive instances in which the user did not provide negative feedback. In other embodiments, the machine learning training module 260 may identify negative instances of feedback where users provided negative feedback on the message intervention.

As described above, the feedback on the message intervention provided by the one or more users may include feedback on the reply by the automated action module 250, feedback on an action undertaken by the automated action module 250, or some combination thereof. The feedback may be provided by the sending party and/or the receiving party. The feedback may be disparately weighted between the two parties, e.g., the machine learning training module 260 weights feedback from the receiving party than the sending party. As an example, a data instance in the fine-tuning training data includes a message by a sending party, an intervened reply to the message, and an intervened action undertaken triggered by the message. The machine learning training module 260 may utilize the fine-tuning training data to fine-tune the model to better predict (1) whether a message is action-oriented, (2) one or more example replies to a message, and (3) one or more desired actions triggered by the message.

In one or more embodiments, the machine learning training module 260 trains or fine-tunes parameters of the machine-learned model deployed by the model serving system 150 based on a training dataset. In one or more embodiments, the machine learning training module 260 fine-tunes parameters by obtaining previous instances of conversations between requesting users and fulfillment users and identifying correct instances of actions to messages. As an example, a prompt in a data instance may be a user requests additional items to be added to an order (e.g., message is “can I add organic grapes to my order?” and the positive output is a set of actions (e.g., “add organic grapes to order for user account 12345 via add order API call”) triggered by the fulfillment user that eventually led to adding the requested item to the user's order).

The machine learning training module 260 obtains such pairs of prompts and positive outputs for the training dataset. The machine learning training module 260 encodes the data into a set of input tokens, where a token is a numerical vector representing a word, sub-word, or phrase in a latent space. When the transformer architecture of the machine-learned model (e.g., LLM) is of an autoregressive architecture, the LLM may be applied to generate one or more output tokens that correspond to the positive outputs. An output token is decoded to determine a probability that the decoded token corresponds to a corresponding token in the positive output.

The machine learning training module 260 determines a loss function across the one or more output tokens that indicates a difference (e.g., logit difference) between the tokens in the positive outputs and the output tokens generated by the forward pass of the transformer model. As an example, the loss function may be an NLP loss for each token combined across one or more output tokens generated for the positive text. The machine learning training module 260 obtains one or more terms from the loss function and performs backpropagation to update parameters of the transformer architecture.

After the machine-learned model has been fine-tuned, the machine-learned model may be used for inference to generate automated actions as described above. The machine learning training module 260 may further obtain data instances (prompt and positive outputs) that received positive feedback from the user (e.g., via the UI elements) and construct a second or another training dataset. The second training dataset is used to further fine-tune the parameters of the machine-learned model. As an example, a data instance may be a prompt including the message “What is your buzzer code” along with contextual information including previous chats or exchanges between the users. The positive outputs are a set of actions including first confirming whether all items for the order have been shopped and whether the fulfillment user is ready for delivery to the requesting user and automatically presenting the buzzer code 1234 obtained from the previous chats to a UI of the fulfillment device when the fulfillment user is ready.

The data store 270 stores data used by the online system 140. For example, the data store 270 stores requesting user data, item data, order data, and fulfillment user data for use by the online system 140. User data may be stored in profiles, wherein the user data may have varying levels of accessibility by other users. For example, a requesting user's delivery address is not generally accessible, and would only be provided to a fulfillment user in the course of fulfilling an order on behalf of the requesting user. The data store 270 also stores trained machine learning models trained by the machine learning training module 260. For example, the data store 270 may store the set of parameters for a trained machine learning model on one or more non-transitory, computer-readable media. The data store 270 uses computer-readable media to store data, and may use databases to organize the stored data.

With respect to the machine-learned models hosted by the model serving system 150, the machine-learned models may already be trained by a separate entity from the entity responsible for the online system 140. In another embodiment, when the model serving system 150 is included in the online system 140, the machine-learning training module 260 may further train parameters of the machine-learned model based on data specific to the online system 140 stored in the data store 270. As an example, the machine-learning training module 260 may obtain a pre-trained transformer language model and further fine tune the parameters of the transformer model using training data stored in the data store 270. The machine-learning training module 260 may provide the model to the model serving system 150 for deployment.

### Example Messaging User Interface

FIG. 3 is an example messaging user interface 300 provided by the messaging module 240, in accordance with some embodiments. The messaging user interface 300 includes message history 310 and an input field 340. Within the message history 310, users communicating with one another can see received messages 320 and sent messages 330. Received messages 320 may indicate a sender, e.g., in embodiments with multiple users communicating in one channel, or in embodiments where the automated action module 250 intervenes with a reply or an action on behalf of another user. In the example illustration shown, a sending party (e.g., a requesting user) sends a message:
“Thanks Jennifer, can I add organic grapes and cancel the blueberries?
   In response, the automated action module 250 may perform message intervention to determine that the message by the sending party is an action-oriented message. Here, in the example, the automated action module 250 may further perform one or more automated actions: (1) a first action to add a substitution item to the order, and (2) a second action to remove the unavailable item from the order. The automated action module 250 may further provide an automated reply through the messaging user interface 300, e.g., confirming the performed actions:
“ABC Co.: organic grapes have been added to your order number 123.”
“ABC Co.: organic blueberries have been canceled from your order number 123.”
   The automated action module 250 may, in conjunction with the messaging user interface 300, further provide feedback options, e.g., in the form of positive (e.g., thumbs up button) or negative (e.g., thumbs down button) indication elements.

The input field 340 provides one or more options for content that may be communicated through the messaging user interface 300. For example, the input field 340 may include options for sending images or video from the client device, an option for sending text, and an option for accessing other types of data from other applications of the client device. Alternative embodiments may include more, fewer, or different display components than those illustrated in FIG. 3. Other embodiments of the messaging user interface 300 may variably position each of the display components.

Message Intervention with Automated Reply(Ies) and/or Action(s)

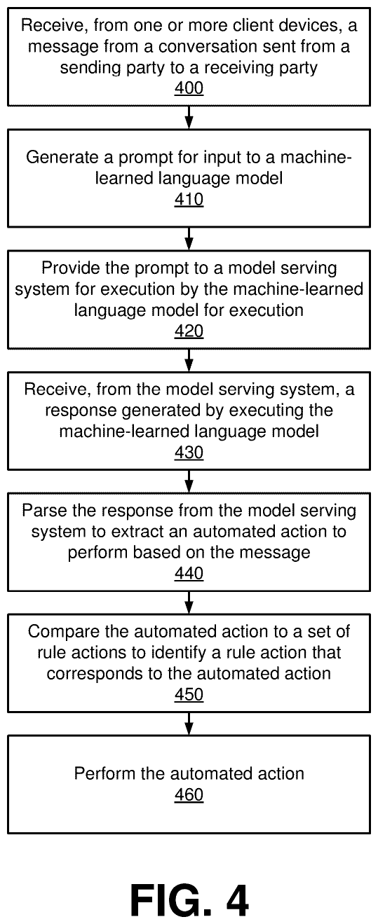

FIG. 4 is a flowchart for a method of inferring whether to intervene in conversations between users of an online system, in accordance with one or more embodiments. Message intervention may entail responding with an automated reply or performing an automated action according to a received message. These steps may be performed by an online system (e.g., online system 140). Additionally, each of these steps may be performed automatically by the online system without human intervention. Alternative embodiments may include more, fewer, or different steps from those illustrated in FIG. 4, and the steps may be performed in a different order from that illustrated in FIG. 4.

The online system 140 receives 400, from one or more client devices, a message from a conversation sent from a sending party to a receiving party. The parties may be users of the online system 140, e.g., a requesting user or a fulfillment user. In some embodiments, the users may be communicating over an order by the requesting user and being fulfilled by the fulfillment user. As some examples, messages by the requesting user may involve order modifications or inquiries relating to item inventory at the fulfillment location. As other examples, messages by the fulfillment user may involve replacement workflows or inquiries relating to order or delivery instructions.

The online system 140 generates 410a prompt for input to a machine-learned language model. The prompt may specify at least the message and a request to infer whether an automated action can be performed for the message. In particular embodiments, the prompt requests inference to predict (1) whether the message sent by the sending party was an action-oriented message, (2) one or more example automated replies that may be used in intervention by the online system 140, (3) one or more desired actions to be performed based on the message, or some combination thereof. The machine-learned language model may be trained to provide a response with the requested inference(s). In some embodiments, the machine-learned model may have knowledge of previous communications between the two users. Armed with the knowledge base, the machine-learned model's inference predictions may be tailored to the communication between the users.

The online system 140 provides 420 the prompt to a model serving system for execution by the machine-learned language model for execution. The model serving system may receive the prompt and input the prompt into the machine-learned language model.

The online system 140 receives 430, from the model serving system, a response generated by executing the machine-learned language model on the prompt. The response may indicate responses to each inference request. For example, the response may indicate (1) whether the message sent by the sending party was an action-oriented message, (2) one or more example automated replies that may be used in intervention by the online system 140, (3) one or more desired actions to be performed based on the message, or some combination thereof.

The online system 140 parses 440 the response from the model serving system to extract (1) whether the message sent by the sending party was an action-oriented message, (2) one or more example automated replies that may be used in intervention by the online system 140, (3) one or more desired actions to be performed based on the message, or some combination thereof. The response may also indicate a confidence with the inference (for each inference prediction, or holistically). If the message was not action-oriented, but was an inquiry, the online system 140 may intervene with an automated reply based on information known to the online system 140.

The online system 140 compares 450 the automated action extracted from the response to a set of rule actions to identify whether a rule action that corresponds to the automated action is present in the set of rule actions. The set of rule actions operate have a gatekeeping effect to ensure the online system 140 intervenes in permitted scenarios. The online system 140 may use a mapping algorithm to map the extracted automated actions to one or more of the rule actions.

Responsive to identifying that the corresponding rule action is present, the online system 140 performs 460 the automated action and, optionally, sends an automated reply to the sending party of the conversation. If there's no mapping to a corresponding rule action, the online system 140 may forgo intervention and may prompt the receiving party to provide a manual reply.

Upon performing the automated action and, optionally, sending the automated reply, the online system 140 may collect feedback on the message intervention. For example, the online system 140 may collect a binary indication of whether the message intervention was positive or negative, and/or may include additional detail, e.g., automated reply tonality was off, automated action that was performed was not intended, etc. The online system 140 may use the feedback in fine-tuning the machine-learned language model.

### Additional Considerations

The foregoing description of the embodiments has been presented for the purpose of illustration; many modifications and variations are possible while remaining within the principles and teachings of the above description. Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine learning models in the performance of their described functionalities. A “machine learning model,” as used herein, comprises one or more machine learning models that perform the described functionality. Machine learning models may be stored on one or more computer-readable media with a set of weights. These weights are parameters used by the machine learning model to transform input data received by the model into output data. The weights may be generated through a training process, whereby the machine learning model is trained based on a set of training examples and labels associated with the training examples. The training process may include: applying the machine learning model to a training example, comparing an output of the machine learning model to the label associated with the training example, and updating weights associated for the machine learning model through a back-propagation process. The weights may be stored on one or more computer-readable media, and are used by a system when applying the machine learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or”. For example, a condition “A or B” is satisfied by any one of the following: A is true (or present) and B is false (or not present), A is false (or not present) and B is true (or present), and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A method comprising:
receiving, from one or more client devices, a message from a conversation sent from a sending party to a receiving party on a communication interface, wherein the sending party and the receiving party are users of an online system;
generating a prompt for input to a machine-learned language model, the prompt specifying at least the message and a request to infer whether an automated action can be performed for the message;
providing the prompt to a model serving system for execution by the machine-learned language model;
receiving, from the model serving system, a response generated by executing the machine-learned language model on the prompt;
parsing the response from the model serving system to extract an automated action to perform based on the message;
comparing the automated action extracted from the response to a set of rule actions to identify a rule action that corresponds to the automated action; and
responsive to identifying that a corresponding rule action is present, performing the automated action.

2. The method of claim 1, wherein each order includes a list of one or more items to be obtained at a fulfillment location.

3. The method of claim 1, wherein the sending party is a first requesting user, the receiving party is a first fulfillment user, and the message indicates an inquiry or a modification to a first order by the first requesting user that is assigned to the first fulfillment user.

4. The method of claim 1, wherein the sending party is a first fulfillment user, the receiving party is a first requesting user, and the message indicates an inquiry to delivery instructions related to a first order by the first requesting user that is assigned to the first fulfillment user.

5. The method of claim 1, wherein generating the prompt further comprises:
generating the prompt further specifying another request to predict the automated action to be performed by the online system.

6. The method of claim 5, wherein generating the prompt further comprises:
generating the prompt further specifying another request to predict an automated reply that the online system can provide to the sending party.

7. The method of claim 6, wherein generating the prompt further comprises:
generating the prompt further specifying previous conversations between the sending party and the receiving party, wherein the response generated by the machine-learned language model is informed by the previous conversations.

8. The method of claim 6, wherein parsing the response from the model comprises:
parsing the response to identify the automated action predicted based on the prompt and the automated reply predicted based on the prompt.

9. The method of claim 1, wherein performing the automated action comprises:
modifying a first order inclusive of a list of items, the first order being fulfilled between the sending party and the receiving party; or
modifying delivery instructions of the first order being fulfilled.

10. The method of claim 1, wherein the machine-learned language model is trained by:
retrieving past conversations between the requesting users and the fulfillment users of the online system;
identifying one or more actions performed by the online system in response to the past conversations; and
training the machine-learned language model with the past conversations and the identified one or more actions.

11. The method of claim 10, further comprising:
receiving feedback from the sending party or the receiving party in response to the automated action performed; and
fine-tuning the machine-learned language model with the feedback.

12. The method of claim 1, further comprising:
responsive to identifying that there is no corresponding rule action present, prompting the client device of the receiving party to provide a manual reply.

13. A non-transitory computer-readable storage medium storing instructions that, when executed by a computer processor, cause the computer processor to perform operations comprising:
receiving, from one or more client devices, a message from a conversation sent from a sending party to a receiving party on a communication interface, wherein the sending party and the receiving party are users of an online system;
generating a prompt for input to a machine-learned language model, the prompt specifying at least the message and a request to infer whether an automated action can be performed for the message;
providing the prompt to a model serving system for execution by the machine-learned language model;
receiving, from the model serving system, a response generated by executing the machine-learned language model on the prompt;
parsing the response from the model serving system to extract an automated action to perform based on the message;
comparing the automated action extracted from the response to a set of rule actions to identify a rule action that corresponds to the automated action; and
responsive to identifying that a corresponding rule action is present, performing the automated action.

14. The non-transitory computer-readable storage medium of claim 13, wherein the sending party is a first requesting user, the receiving party is a first fulfillment user, and the message indicates an inquiry or a modification to a first order by the first requesting user that is assigned to the first fulfillment user.

15. The non-transitory computer-readable storage medium of claim 13, wherein the sending party is a first fulfillment user, the receiving party is a first requesting user, and the message indicates an inquiry to delivery instructions related to a first order by the first requesting user that is assigned to the first fulfillment user.

16. The non-transitory computer-readable storage medium of claim 13, wherein generating the prompt further comprises:
generating the prompt further specifying: a second request to predict the automated action to be performed by the online system, and a third request to predict an automated reply that the online system can provide to the sending party.

17. The non-transitory computer-readable storage medium of claim 16, wherein generating the prompt further comprises:
generating the prompt further specifying previous conversations between the sending party and the receiving party, wherein the response generated by the machine-learned language model is informed by the previous conversations.

18. The non-transitory computer-readable storage medium of claim 13, wherein the machine-learned language model is trained by:
retrieving past conversations between the requesting users and the fulfillment users of the online system;
identifying one or more actions performed by the online system in response to the past conversations; and
training the machine-learned language model with the past conversations and the identified one or more actions.

19. The non-transitory computer-readable storage medium of claim 13, the operations further comprising:
receiving feedback from the sending party or the receiving party in response to the automated action performed; and
fine-tuning the machine-learned language model with the feedback.

20. A system comprising:
a computer processor; and
a non-transitory computer-readable storage medium storing instructions that, when executed by the computer processor, cause the computer processor to perform operations comprising:
receiving, from one or more client devices, a message from a conversation sent from a sending party to a receiving party on a communication interface, wherein the sending party and the receiving party are users of an online system;
generating a prompt for input to a machine-learned language model, the prompt specifying at least the message and a request to infer whether an automated action can be performed for the message;
providing the prompt to a model serving system for execution by the machine-learned language model;
receiving, from the model serving system, a response generated by executing the machine-learned language model on the prompt;
parsing the response from the model serving system to extract an automated action to perform based on the message;
comparing the automated action extracted from the response to a set of rule actions to identify a rule action that corresponds to the automated action; and
responsive to identifying that a corresponding rule action is present, performing the automated action.
